(19) United States
(12) Patent Application Publication
(10) Pub. No.: US 2015/0000185 A1
(43) Pub. Date: Jan. 1, 2015

(54) METHOD FOR USE IN THE EXTERMINATION OF BED BUG INFESTATIONS

(71) Applicant: GREGORY ALLEN PRATT, TOBACCOVILLE, NC (US)

(72) Inventor: GREGORY ALLEN PRATT, TOBACCOVILLE, NC (US)

(21) Appl. No.: 14/490,650

(22) Filed: Sep. 18, 2014

Related U.S. Application Data
(62) Division of application No. 13/527,875, filed on Jun. 20, 2012.
(60) Provisional application No. 61/499,014, filed on Jun. 20, 2011.
(60) Provisional application No. 61/553,985, filed on Nov. 1, 2011.

(51) Int. Cl. A01M 1/20; A01M 5/02

(52) U.S. Cl. CPC A01M 1/2094; A01M 5/02
USPC 43/132.1

(57) ABSTRACT

The invention disclosed is a method for the extermination of household pests, particularly bed bugs, found upon furniture, furnishings, and personal effects (“infested items”), whereby the infested items may be removed from their usual household environment (i.e., removal of a bed from an infested bedroom, etc.) and placed within an apparatus that then increases the temperature of the infest items to a degree lethal to the respective pest sought to be eradicated.

### CROSS-REFERENCE TO RELATED APPLICATIONS

This application claims the benefit of U.S. Provisional Application Ser. No. 61/499,014 filed Jun. 20, 2011, which is hereby incorporated by reference in its entirety.

This application further claims the benefit of U.S. Provisional Application Ser. No. 61/553,985 filed Nov. 1, 2011, which is also hereby incorporated by reference in its entirety.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

1. Field of the Invention.

The present invention relates generally to methods and apparatuses for destroying insects upon furniture, furnishings and personal effects, and more particularly to methods and apparatuses that destroy bed bugs upon furniture, furnishings and personal effects.

In more detail, the present invention relates to extermination of insects in household settings, for example bed bugs in a bedroom, by subjecting them to a suitably elevated temperature for a sufficient time to kill them but without damaging the furniture, furnishings and personal effects which they infest.

2. Brief Description of the Related Art.

Bed bugs are small insects that feed solely on the blood of animals. The common bed bug, Cimex Lectularus, is the species of bed bug that has most adapted to living with humans. It is found in temperate climates throughout the world and has been known since ancient times. When it feeds, the bug pierces the skin and withdraws the blood of its host. Bites typically present as a rash or skin inflammation caused by a dermatological reaction to chemicals orally injected in the skin of the host animal during feeding.

There are many aspects of bed bugs that make it difficult to eradicate them once they have established a presence in a location. Adult bed bugs are about ¼ inch or about 6 millimeters long, 5-6 millimeters wide, and reddish-brown with oval, flattened bodies. Immature nymphs are similar in appearance to the adults but smaller and lighter in color. Female bed bugs lay their eggs in secluded areas and can deposit up to five eggs per day, and as many as 500 during a lifetime. Bed bug eggs are very small, almost to the point of being invisible to the naked eye, and when first laid, the eggs are sticky causing them to adhere to surfaces. Bed bugs can go long periods of time without feeding. Nymphs can survive months without feeding and the adults for more than a year. Infestations are therefore not likely to be eliminated by leaving a location unoccupied.

Bed bugs are nocturnal and primarily hide during the daytime in tiny crevices or cracks. Bed bugs are very often found in beds, usually either in the seams of a mattress, in the box spring, or within the structure of the bed itself. They can also be found in a wide variety of locations in a home, such as behind baseboards, within books (especially those near a bed), and within the folds of curtains. Bed bugs tend to congregate but do not build nests like some other insects.

Bed bug infestations arise from a number of different circumstances. Travelers frequently acquire bed bugs at hotels, motels, and bed-and-breakfasts, and the problem is exacerbated by increased domestic and international tourism. Upon acquiring bed bugs many people unknowingly bring them back to their homes in their luggage. Bed bugs may be further transported into the home by bringing infested furniture and clothing into the household. In condominiums and apartment buildings bed bugs may also travel between units upon gaining entry to the building by the above common means.

The symptoms of bed bug bites are very similar to other biting insects such as ticks and/or mosquitos and, therefore, are not easily identified without actually witnessing bed bugs in the home. As a result, bed bug infestations tend to go long periods without being diagnosed and treated.

Due to many of the above referenced characteristics of bed bugs, the organisms can be difficult to eradicate and infestations can prove stubborn at best. In fact, traditional pest treatment methods have limited success in the treatment of bed bugs, and specialists, even within the pest control industry itself, are frequently needed to properly treat an infested residence. Most professionals claim that it takes several treatments in order to be fully rid of the infestation. However, without being fully rid of the infestation, the bed bugs will just lay more eggs and continue to re-infest the home or other dwelling.

As with all insects, bed bugs have a temperature range within which they can survive and thrive. Significant departures from this temperature range are instantly lethal, while temperatures slightly outside the range can be lethal if maintained for sufficient periods of time. The physiology behind the temperature induced death of insects, and bed bugs in particular, is beyond the scope of the present inventor's concern—causing the phenomenon of death itself is the express purpose of the invention. Of secondary importance to the invention is the fact that the effective use of thermal treatments of the type herein espoused avoids the use of harmful and toxic chemicals and fumigation procedures. The latter can be both unhealthy and inconvenient to humans in practice.

### BRIEF SUMMARY OF THE INVENTION

Although the background art is no stranger to the concept of treating infestations of household pests using means to elevate temperatures to a degree lethal to the pest, the background art struggles with the concept of doing the same in an effective and convenient manner and, accordingly, the methods, processes, and devices found in the prior art tend to struggle with accomplishing thermal treatment of pest infestations within a household environment in an effective and convenient manner. Specifically, extermination of household pests, particularly bed bugs, requires not only treatment of the household environment, but rather, isolation and treatment of the furniture, furnishings, and personal effects upon and within which pests may reside.

It is a primary objective of the present invention to provide a convenient and effective means for the isolation and treatment of furniture, furnishings, and personal facts located within an infested household environment.

It is a further objective in the present invention to provide for the application of extreme temperatures to furniture, furnishings, and personal effects within a controlled environment so as not to compromise safety and/or potentially damage property by attempting the same within the actual infested household environment.

It is a still further objective of the present invention to provide a mobile unit designed to treat a high volume of pest infestations, particularly bed bug infestations, in several varying locales without difficulty or substantial hardship to an operator.

It is a still further objective of the present invention to provide a controlled environment capable of quickly reaching and readily maintaining consistent temperatures in excess of 170.0° F., a temperature far exceeding the 122.5° F. known lethal to bed bugs, for the purpose of quickly raising the temperature of the entirety of each article of treated furniture, furnishings and personal effects to the 122.5° F. known lethal to bed bugs.

It is a still further objective of the present invention to provide a controlled environment capable of containing a large number and volume of furniture, furnishing, and personal effect items desired to be treated for pest infestation.

These and other advantages of the present disclosed apparatus will become apparent to one skilled in the art in view of the figures and descriptions of the figures stated below.

### BRIEF DESCRIPTION OF THE SEVERAL VIEWS OF THE DRAWING

The aforementioned advantages of the invention, as well as additional advantages thereof will be more fully understood as a result of a detailed description of the preferred embodiment when taken in conjunction with the accompanying drawings in which:

FIG. 1 is an overhead view of the floor plan of the preferred embodiment of the presented apparatus.

FIG. 2 is a rear perspective view of the contemplated best mode of the presented apparatus, the presented view being into the cavity of the chamber environment from behind the apparatus.

FIG. 3 is a side perspective view of the preferred embodiment of the presented apparatus, the presented view being into a control room from which a user may operate the apparatus.

FIG. 4 is an interior perspective view of the preferred embodiment of the presented apparatus, the presented view being the interior of a control room from which a user may operate the apparatus.

FIG. 5 is a second rear perspective view of the preferred embodiment of the presented apparatus, the presented view being into the cavity of the chamber environment from behind the apparatus, this view specifically focusing upon ductwork contemplated in the preferred embodiment.

FIG. 6 is an overhead view of the preferred embodiment of the presented apparatus.

### DETAILED DESCRIPTION OF THE INVENTION

The first invention presently disclosed is a mobile apparatus for use in the extermination of household pests, particularly bed bugs, found upon furniture, furnishings, and personal effects (“infested items”), whereby the infested items may be removed from their usual household environment (i.e., removal of a bed from an infested bedroom, etc.) and placed within the apparatus that then increases the temperature of the infested items to a degree lethal to the respective pest sought to be eradicated. Of specific concern is the eradication of all life cycles of bed bugs living or attached within or upon the infested items. After utilizing the now presented apparatus, the formerly infested items are returned to their customary surroundings upon the treatment and extermination of pest infestations on or within the formerly infested items.

In broad embodiment the first disclosed invention is a mobile apparatus for use in the treatment and extermination of bed bugs or other pests found upon furniture, furnishings and personal effects (“infested items”) whereby infested items may be removed from their immediate infested surroundings (i.e., removal of a bed from an infested bedroom, etc.) and placed within the apparatus and wherein all life cycles of pest living within or upon the infested items are exterminated via increasing the temperature within the apparatus to a level lethal to the pest being exterminated, the apparatus comprising a mobile chamber, heating means sufficient to raise the interior temperature of the trailer to a degree lethal to household pests and an access door whereby the chamber may be loaded and unloaded.

It is contemplated that the manner and process of using the now disclosed apparatus would entail a method of conveniently exterminating household pests at a variety of locations, the method comprising delivery of the now disclosed apparatus to a location determined by a user; placement of furniture items and other furnishings in contact with household pests within the interior of the mobile chamber; activation of the heating means so as to raise the internal temperature of the mobile chamber to a degree lethal to household pests; maintaining the internal temperature of the mobile chamber at a degree lethal to household pests for a period to allow the entirety of each furniture item and other furnishing in contact with household pests to be raised in temperature to a degree lethal to household pests; deactivation of the heating means so as to allow the internal temperature of the mobile chamber and each furniture item and other furnishing to fall to room temperature; and removal of the furniture items and other furnishings from the interior of the mobile chamber and return of the same to their usual household location and position.

The preferred embodiment of the disclosed apparatus is an enclosed trailer of the type frequently towed behind a vehicle, having integrated within its interior heating means comprising two forced-air furnace units sufficient to raise the interior temperature of the trailer to a degree lethal to household pests coupled with a system of ductwork having at least one vent and one plenum also affixed and integrated to the interior of the trailer. The integrated forced-air furnace units and ductwork system are critical to the complete, even and consistent heating of the entirety of the interior of the enclosed trailer, the contents thereof, and the speed with which the interior may reach optimal temperatures when in use. The inventor notes that the furnace units may be fueled by the combustion of any of a variety of hydrocarbon fuel sources, though the preferred fuel sources are expressly of the class light propane and/or diesel.

The best mode of the invention is the apparatus, as described, wherein said enclosed trailer has a partitioned section defined by an insulated partition wall, the contemplated partition defining a first furnace-heated square footage “kill zone” wherein infested items are loaded and treated under extreme temperatures and a second climate controlled square footage “control room” wherein an operator may comfortably stand, observe, and operate the apparatus without being exposed to the extreme temperatures occurring in the “kill zone”. Further, the best mode of the invention contemplates that the interior-integrated forced-air furnace units are high efficiency 90-plus units with programmable thermostat, the thermostat being capable of manipulation by a user to raise or lower the temperature within the enclosed chamber environment per user preferences. Still further, the best mode of the invention contemplates means of access to the enclosed trailer being a rear door to the enclosed trailer, said door being mounted on a horizontal hinge along the rear terminus of the “kill zone” square footage of the enclosed trailer allowing said door to be configured in a vertical “closed” configuration, wherein the trailer and “kill zone” is completely enclosed with said door acting as the rear vertical planar wall of the enclosure, or a horizontal or diagonal “open” configuration, wherein the enclosed trailer and “kill zone” has no rear vertical planar wall and is completely open to the exterior environment and wherein the door itself takes on the added functionality of a loading dock or ramp for the placement of interior furnishings and personal effects within the chamber environment as contemplated in the use of the apparatus.

These and other embodiments will be more fully understood when considered in conjunction with the accompanying drawings and following detailed description of the invention.

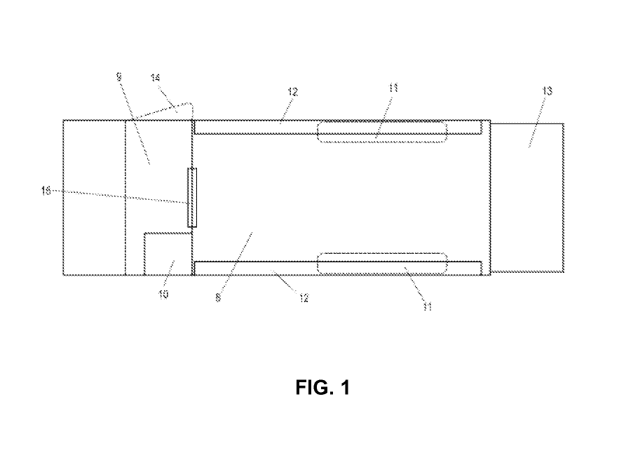

Referring now to the above referenced preferred embodiment in more detail, in FIG. 1 there is shown an overhead view of the floor plan of the preferred embodiment wherein the apparatus is partitioned into two areas of primary importance, a first furnace-heated square footage “kill zone” 8 and a second climate controlled square footage “control room” 9 wherein an operator may comfortably stand, observe and operate at least a single forced-air furnace unit 10 outputting heated air and thus regulating the temperature within the “kill zone” 8. Further shown in this FIG. 1 floor plan of the preferred embodiment are wheel wells 11 located within the “kill zone” 8 intended to reflect the existence of at least two (2) wheels interacting with the ground, supporting the apparatus and allowing for mobility of the apparatus. Still further shown in this FIG. 1 floor plan of the preferred embodiment is the preferred system by which the temperature within the “kill zone” 8 is raised and lowered per operator discretion, namely at least a single forced-air furnace unit 10, the unit 10 being physically located within the “control room” 9 and outputting heated air to a system of ductwork 12 having a plurality of vents and plenums through which the heated air is evenly and consistently distributed throughout the “kill zone” 8. Still further shown in this FIG. 1 floor plan of the preferred embodiment, is the means of access 13 to the “kill zone” 8, in the case shown, being a rear door 13 to the “kill zone” 8 deployed in an open orientation on a horizontal plane parallel with the ground and, when in this orientation, doubling as a loading dock 13 for the “kill zone” 8. Still further shown in this

FIG. 1 floor plan of the preferred embodiment, is the contemplated partitioned “control room” 9 featuring an independent access means 14 and a window 15 breaching the partition between “control room” 9 and the “kill zone” 8 whereby an operator located within the “control room” 9 may monitor the heating and cooling of interior furnishings and personal effects located within the “kill zone” 8 during use of the apparatus.

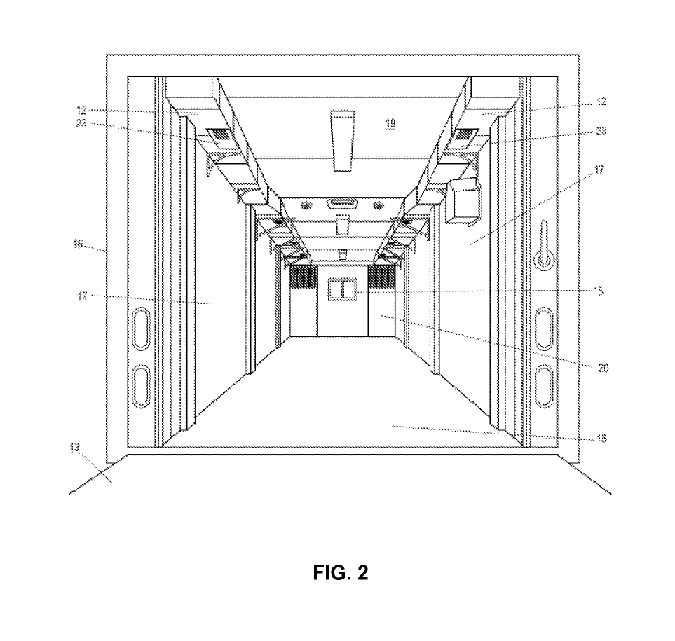

Referring now to the above referenced best mode in more detail, in FIG. 2 there is shown a rear perspective view of the contemplated “kill zone” square footage, the presented view being into the cavity of the “kill zone” from the rear of the apparatus. Specifically, FIG. 2 shows the rear of the contemplated enclosed trailer 16 with the rear door 13 configured in the “open” configuration, thus allowing a view into the entirety of the cavity of the “kill zone”, said cavity defined by a floor 18, two side walls 17, a ceiling 19, and a partition wall 20. Specifically, the two side walls 17 of the trailer are insulated thermal walls 17, the trailer floor 18 is an insulated thermal floor 18, the trailer ceiling 19 is an insulated thermal ceiling 19, and the partition wall 20 defining the “kill zone” and the “control room” partitions of the trailer 16 is an insulated thermal partition wall 20. Still further shown in this FIG. 2 perspective view of the best mode is the contemplated system of ductwork having a plurality of vents 23 and plenums 12 directly attached and integrated with the contemplated forced-air furnace units in the “control room”, thus facilitating the delivery of heated air evenly and consistently throughout the “kill zone”, said ductwork system, plenums 12, and vents 23 being arranged at the confluence of the thermal walls 17 with the thermal ceiling 19 and running the length of the interior of the “kill zone” within the enclosed trailer 16. Still further shown in this FIG. 2 perspective view of the best mode is a partition window 15 breaching the thermal partition wall 20 between the “control room” and the “kill zone” whereby a user located within the “control room” may monitor the heating and cooling of interior furnishings and personal effects located within the “kill zone” during use of the apparatus without the operator himself being exposed to the extreme temperatures present in the “kill zone”.

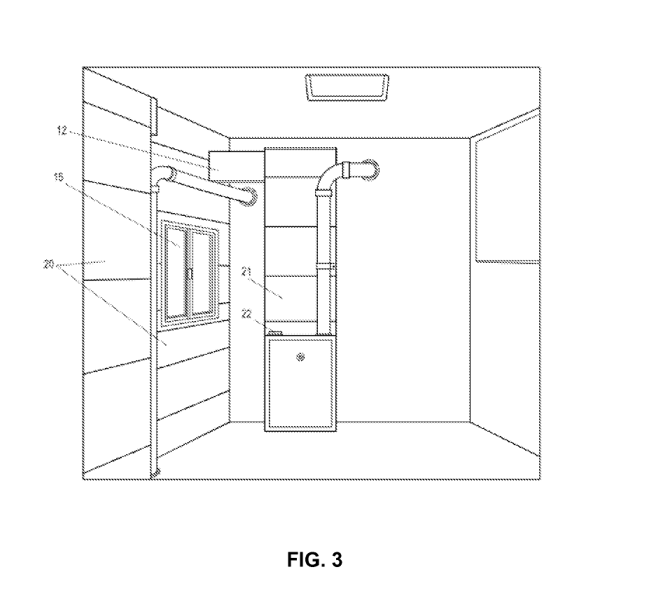

Referring now to the above referenced best mode in still further detail, in FIG. 3 there is shown a side perspective view of the “control room” as contemplated in the best mode, the presented view being into the “control room” from the point of view of an operator entering the “control room” from a dedicated means of access from the side of the enclosed trailer. Specifically,

FIG. 3 shows the “control room” side of the thermal partition wall 20 and partition window 15 breaching the thermal partition wall 20 as depicted in FIG. 2 and described above. Still more specifically, FIG. 3 shows a single forced-air furnace unit 21 located within the “control room” and delivering heated air into the ductwork system plenums 12 that breach the thermal partition wall 20 and ultimately deliver said heated air into the cavity of “kill zone” located on the opposite side of the thermal partition wall 20. Still further shown in this FIG. 3 perspective view, is a programmable thermostat 22 coupled to the forced-air furnace unit 21, intended for manipulation by an operator to regulate the output of heated air from the forced-air furnace unit 21. Due to the angle of view in FIG. 3 only a single forced-air furnace unit 21 is depicted despite the fact that the inventor expressly contemplates a second forced-air furnace unit 21 opposite the first, and now depicted, forced-air furnace unit 21, said second forced-air furnace unit to be located at the opposite terminus of the thermal partition wall 20 and being similarly integrated with dedicated ductwork system plenums 12 that breach the thermal partition wall 20 and ultimately deliver said heated air into the cavity of “kill zone” located on the opposite side of the thermal partition wall 20. Further, the contemplated second forced-air furnace unit 21 would further be coupled with a dedicated programmable thermostat 22 to allow for the independent regulation of the second forced-air furnace unit 21.

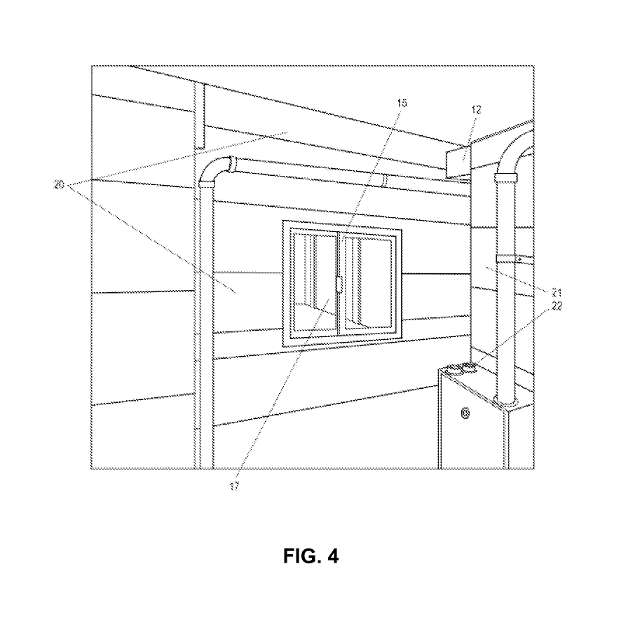

Referring now to the above referenced best mode in still further detail, in FIG. 4 there is shown an interior perspective view of the “control room” as contemplated in the best mode, the presented view being the interior of the “control room” from the point of view of an operator standing within the “control room” and looking through a the thermal partition wall 20 window 15 depicted in FIG. 2 and FIG. 3 and as described above. Specifically, FIG. 4 shows an alternative perspective of the single forced-air furnace unit 21 depicted in FIG. 3 and an improved view of the programmable thermostat 22 depicted in FIG. 3. Still more specifically, FIG. 4 shows an alternative view of integration between the single forced-air furnace unit 21 located within the “control room” delivering heated air into the ductwork system plenums 12 that breach the thermal partition wall 20 and ultimately deliver said heated air into the cavity of the “kill zone” on the opposite side of the thermal partition wall 20. Still further shown in this FIG. 4 perspective view, is the view through the thermal partition 20 window 15, allowing oversight of the “kill zone” and, specifically in the case of FIG. 4, a view of a thermal wall 17 of the trailer.

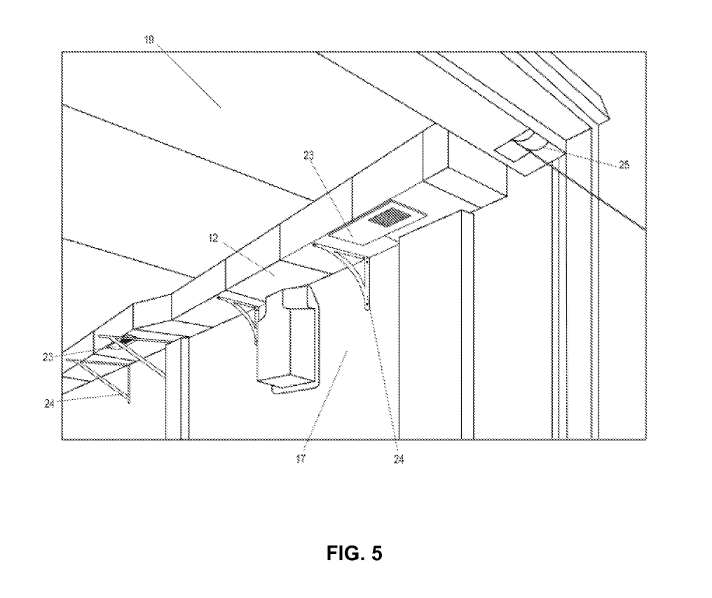

Referring now to the above referenced best mode in still further detail, in FIG. 5 there is shown a second rear perspective view of the best mode, the presented view being into the cavity of the “kill zone” from the rear of the apparatus, this view specifically focusing upon the ductwork system plenums 12 and plurality of vents 23 contemplated in the best mode. Specifically, FIG. 5 shows the confluence of the insulated thermal side wall 17 of the trailer with the insulated thermal ceiling 19 of the trailer, depicting in detail the ductwork system plenums 12 and vents 23 present and integrated with the interior of the “kill zone” at the confluence of each insulated thermal side wall 17 of the trailer and the insulated thermal ceiling 19 of the trailer. The ductwork system plenums 12 and plurality of vents 23 along the length of the plenums 12 allow for the even, complete and consistent distribution of heated air throughout the “kill zone” and, thus, facilitate the uniform heating of the entire volume of the “kill zone”. In further detail, FIG. 5 depicts the use of rigid brackets 24 securing the ductwork system plenums 12 high upon the insulated thermal wall 17 of the trailer, thus maximizing the volume and capacity of the “kill zone” and allowing for the treatment of a greater volume of infested furniture, furnishings and personal effects per use of the apparatus. FIG. 5 further discloses a pulley assembly 25 whereby the rear door to the “kill zone”, as shown in FIG. 1 and FIG. 2, is supportively engaged and by which pulley assembly 25 the door is opened and closed.

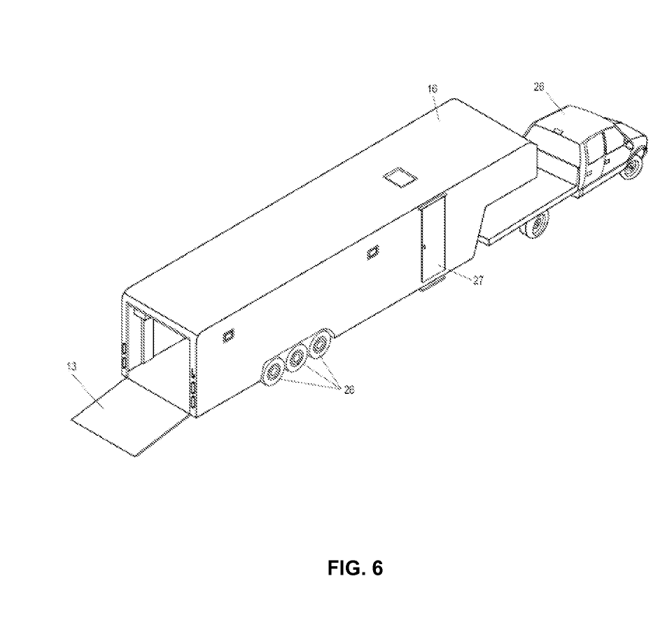

Referring now to the above referenced best mode in still further detail, in FIG. 6 there is shown an exterior overhead view of the best mode, the presented view depicting the enclosed trailer unit 16 being towed by a separate standard pickup truck 26. Specifically, FIG. 6 shows the entirety of the presented apparatus in use. In further detail, FIG. 6 depicts a dedicated “control room” door 27 in a closed configuration and the rear “kill zone” door 13 in an open configuration, further displaying its added functionality as a loading dock or ramp for the loading and unloading of furniture, furnishings and personal effects to and from the “kill zone”. In still further detail, FIG. 6 depicts a plurality of wheels 28 upon which the enclosed trailer unit 16 supportively rests and the functionality of which allows for the mobility of the overall apparatus.

While the foregoing written description of the disclosed invention enables one of ordinary skill to practice and use what is considered presently to be the best mode thereof, those of ordinary skill will understand and appreciate the existence of variations, combinations, and equivalents of the specific embodiment, method and examples herein. The invention should therefore not be limited by the above described embodiment, method and examples, but by all embodiments and methods within the scope and spirit of the invention as claimed.

Further, while specific embodiments of the invention have been illustrated and described herein, it is realized that numerous modifications and changes will occur to those skilled in the art. It is therefore to be understood that the appended claims are intended to cover all such modifications and changes as fall within the true spirit and scope of the invention.

1-17. (canceled)

18. A method of conveniently exterminating household pests at a variety of locations, the method comprising—
delivery of a mobile chamber integrated with heating means sufficient to raise the interior temperature of the trailer to a degree lethal to household pests and an access door whereby the trailer may be loaded and unloaded to a location determined by a user;
placement of furniture items and other furnishings in contact with household pests within the interior of the mobile chamber;
activation of the heating means so as to raise the internal temperature of the mobile chamber to a degree lethal to household pests;
maintaining the internal temperature of the mobile chamber at a degree lethal to household pests for a period to allow the entirety of each furniture item and other furnishing in contact with household pests to be raised in temperature to a degree lethal to household pests;
deactivation of the heating means so as to allow the internal temperature of the mobile chamber and each furniture item and other furnishing to fall to room temperature; and
removal of the furniture items and other furnishings from the interior of the mobile chamber and return of the same to their typical location and position.

19. The method of claim 18 wherein the mobile chamber is an enclosed trailer.
